(19) United States
(12) Patent Application Publication
(10) Pub. No.: US 2012/0271503 A1
(43) Pub. Date: Oct. 25, 2012

(54) BULB OUTAGE DETECTION AND PART NUMBER LOOKUP USING A TELEMATICS-EQUIPPED VEHICLE

(75) Inventors: Kevin W. Owens, Sterling Heights, MI (US); Daniel C. McGarry, Oxford, MI (US); Kurt J. Reichert, Macomb, MI (US)

(73) Assignees: GM GLOBAL TECHNOLOGY OPERATIONS LLC, Detroit, MI (US); GENERAL MOTORS LLC, Detroit, MI (US)

(21) Appl. No.: 13/089,757

(22) Filed: Apr. 19, 2011

(51) Int. Cl. B60Q 11/00; H04W 4/04

(52) U.S. Cl. 701/29.1; 701/34.4

(57) ABSTRACT

An automated system and method for detecting and responding to bulb outages on a vehicle. The method carried out by the system utilizes a telematics unit installed onboard the vehicle and includes the steps of: (a) receiving bulb status information at the telematics unit indicating the failure of a bulb on the vehicle and providing the telematics unit with bulb data for identifying the bulb; (b) obtaining bulb replacement information using the bulb data; and (c) providing the bulb replacement information to a recipient associated with the vehicle. The bulb replacement information can be emailed or otherwise sent electronically to the recipient and can include a replacement part number or other ordering and installation information.

### TECHNICAL FIELD

The present invention relates generally to vehicle telematics and to services provided to customers using the vehicle telematics.

### BACKGROUND OF THE INVENTION

Some vehicles come equipped with monitoring circuitry such as a lamp out warning module that detects a failed bulb and activates an indicator light or other warning message on the instrument panel to alert the driver. However, these warning modules do not provide the operator with any assistance in replacing the failed bulb, other than to perhaps indicate the location of the failed bulb on the vehicle.

### SUMMARY OF THE INVENTION

According to one embodiment of the invention, there is provided a method of detecting and responding to a bulb outage on a vehicle. The method includes the steps of: (a) receiving bulb status information at a telematics unit installed onboard a vehicle, the bulb status information indicating the failure of a bulb on the vehicle and providing bulb data for identifying the bulb; (b) obtaining bulb replacement information using the bulb data; and (c) providing the bulb replacement information to a recipient associated with the vehicle, wherein steps (a)-(c) are carried out automatically using at least one processing device.

In accordance with another embodiment of the invention, there is provided a telematics unit for detecting and responding to a bulb outage on a vehicle. The telematics unit has a processor, computer readable memory accessible by the processor, and wireless communication circuitry connected to the processor. The processor receives messages from other vehicle system modules and communicates with a remote facility via the communication circuitry using a wireless communication system. The processor operates under control of programming stored in the memory to carry out the steps of: (a) receiving, from one of the vehicle system modules, bulb status information that is indicative of the failure of a bulb on the vehicle; (b) presenting a prompt in the vehicle via a vehicle user interface in response to receiving the bulb status information; (c) receiving a reply to the prompt from an occupant of the vehicle; and (d) sending bulb information to the remote facility via the communication circuitry in response to the occupant's reply.

In accordance with yet another embodiment of the invention, there is provided a method of detecting and responding to a bulb outage on a vehicle that includes the steps of: (a) monitoring bulb operation at a plurality of exterior lamp locations on a vehicle; (b) determining an abnormal condition at one of the exterior lamp locations indicative of a bulb outage; (c) providing information indicative of the bulb outage to a telematics unit on the vehicle; (d) sending a bulb outage notification to a recipient associated with the vehicle in response to the information received by the telematics unit, the bulb outage notification prompting the recipient to specify whether bulb replacement information is desired; (e) receiving a reply to the bulb outage notification from the recipient; (f) sending bulb information from the telematics unit to a remote facility in response to the recipient's reply; (g) performing a database lookup at the central facility using the bulb information and obtaining the bulb replacement information via the database lookup; and (h) sending the bulb replacement information electronically to the recipient.

### BRIEF DESCRIPTION OF THE DRAWINGS

One or more preferred exemplary embodiments of the invention will hereinafter be described in conjunction with the appended drawings, wherein like designations denote like elements, and wherein:

FIG. 1 is a block diagram depicting an exemplary embodiment of a communications system that is capable of utilizing the method disclosed herein;

FIG. 2 is a block diagram showing a portion of the communications system of FIG. 1 as it may be used with the method of FIG. 3; and

FIG. 3 is an exemplary method of detecting and responding to a bulb outage that can be carried out using the systems of FIGS. 1 and 2.

### DETAILED DESCRIPTION OF THE ILLUSTRATED EMBODIMENT(S)

The system and method described below can be used to provide enhanced vehicle maintenance support services to a telematics services subscriber or other customer. In particular, the system can detect and respond to a bulb outage on the vehicle by automatically providing bulb replacement information that the customer can use to simplify ordering and/or replacement of the failed bulb or module. This can include querying the customer in the vehicle or elsewhere to determine if the bulb replacement information is desired and, if so, performing a database lookup using bulb data reported from a bulb monitoring circuit to determine the part number or other information needed for ordering the bulb or scheduling service to have it replaced. This simplifies the customer's task in replacing the failed bulb which can be especially useful for exterior vehicle lamps such as those used for forward illumination (e.g., headlamps), signaling (brake and turn signals), marking (e.g., truck marker lamps), and outside area illumination around the vehicle (e.g., puddle lamps). Any type of interior or exterior bulb can be monitored using the method and system described below; for example, incandescent, LED, fluorescent, HID, arc-lamp or any other electronically-activated light source used on the vehicle. Interior bulbs are those used within the vehicle to provide illumination or notifications to an occupant, whereas an exterior bulb (or lamp) is a bulb or bulb module that is used for providing exterior illumination or signaling outside the vehicle, including those used for forward and rear illumination, brake and turn signaling, marker lamps, puddle lamps, etc.

### Communications System

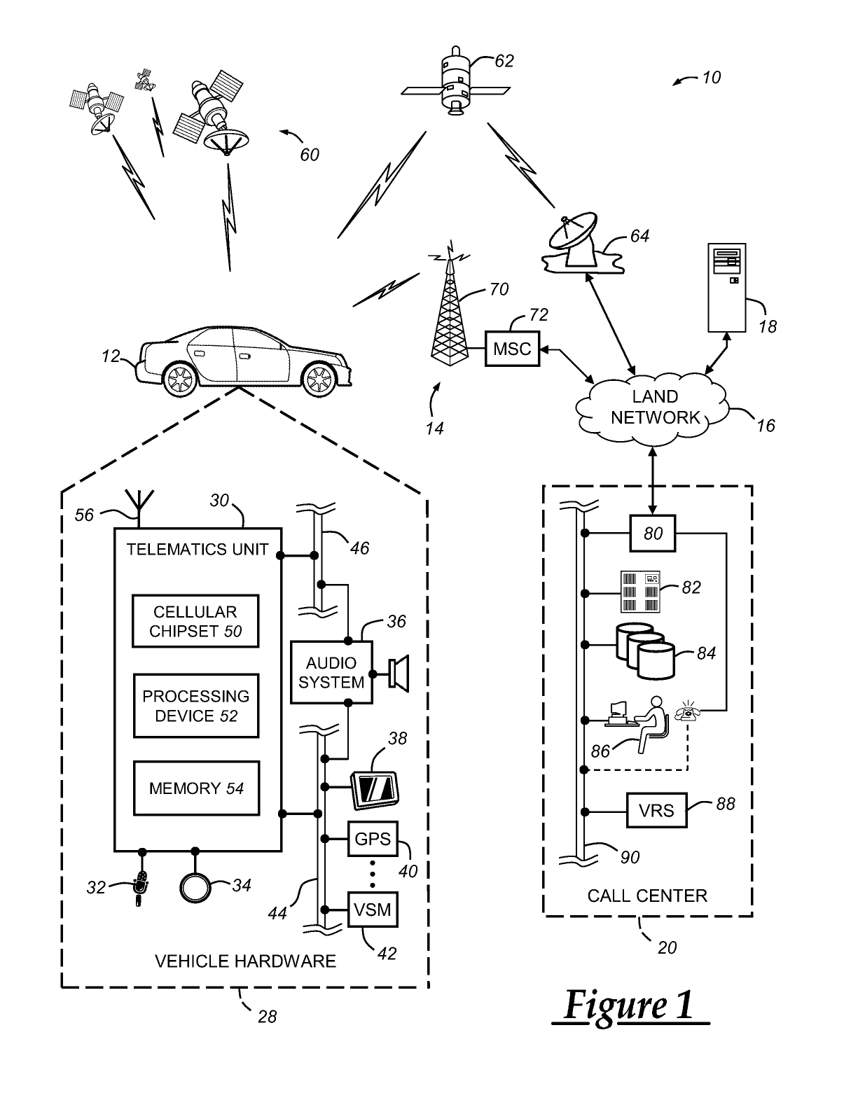

With reference to FIG. 1, there is shown an exemplary operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such exemplary system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that enables wireless voice and/or data communication over wireless carrier system 14 and via wireless networking so that the vehicle can communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM or CDMA standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, such as any of the IEEE 802.11 protocols, WiMAX, or Bluetooth. When used for packet-switched data communication such as TCP/IP, the telematics unit can be configured with a static IP address or can set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

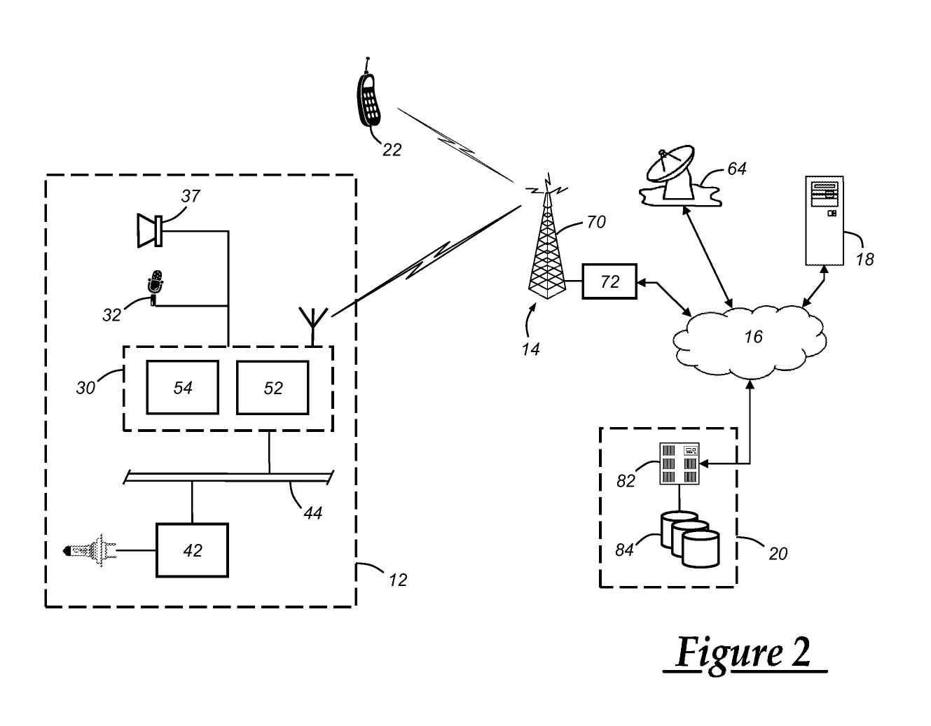

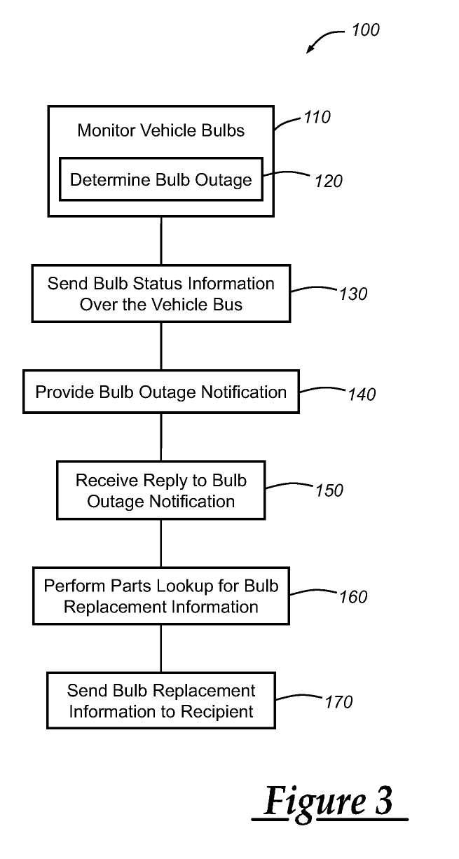

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible. For example, in some embodiments such as are described further below in connection with FIGS. 2 and 3, VSM 42 can be a bulb monitoring circuit (conventional or otherwise) that is capable of sensing an abnormal condition associated with one or more of the vehicle exterior bulbs or lamp modules and providing bulb status information on the vehicle bus 44 that indicates that a bulb has failed and that provides bulb data that can be used to determine specifically which exterior bulb is not working.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated speech processing unit utilizing human-machine interface (HMI) technology known in the art. This speech recognition capability can be built into telematics unit 30 or can be implemented as a separate module. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

Turning now to FIG. 2, there is shown a portion of the communication system 10 of FIG. 1 as it can be used in some embodiments to carry out the bulb outage detection and response method of FIG. 3. The vehicle 12 includes the telematics unit 30 connected to the vehicle bus 44, and also includes a vehicle system module (VSM) 42 in the form of a failed lamp warning module, also referred to herein as a bulb monitoring circuit (BMC) 42. The construction and operation of BMC 42 will be apparent to those skilled in the art based upon that already known in the art and the discussion herein. In some embodiments, the BMC 42 can be a conventional failed lamp warning module that senses an abnormal operational condition of one of the bulbs or bulb modules and provides bulb status information that includes an indication of the failure along with an identification of the bulb or bulb location. In other embodiments, a non-convention failed lamp warning circuit can be used to send the bulb status information. Techniques for automatically monitoring and determining that a bulb has failed are known in the art; for example, by monitoring electric current sent to a bulb or group of bulbs when they are activated and determining whether the measured current is outside a range of expect values (e.g., measuring no current when the lamp is activated can indicate a broken filament in an incandescent lamp). BMC 42 can be integrated in with the circuitry that powers the bulbs or can operate independently of that circuitry. In some embodiments this bulb status information can be sent via communication bus 44 for display via the instrument panel and receipt by telematics unit 30; in other embodiments it can be hardwired directly to telematics unit 30 without the use of any vehicle communication bus. Yet other implementations will become apparent to those skilled in the art.

In the illustrated embodiment of FIG. 2, BMC 42 is connected to the vehicle bus 44 such that, upon determining that a bulb has failed, it sends a message over the bus 44. This message includes the bulb status information. Telematics unit 30 is connected to the bus 44 as discussed above and is programmed to monitor for messages from BMC 42. Having received the bulb status information, telematics unit 30 can take one or more of several actions, including providing a bulb outage notification to the vehicle driver, querying the driver for instructions, obtaining bulb replacement information, and supplying the bulb replacement information to the driver or other designated subscriber. The bulb outage notification can be provided to the driver while in the vehicle; i.e., while the driver is an occupant, either upon detection that the bulb outage occurred or at a later time, such as following a subsequent ignition on event or other triggering event. Additionally or alternatively, the notification can be sent electronically to the driver (customer) such as by text message to the customer's phone 22 or other electronic device, or by email that can be accessed by the customer using their computer 18, and this notification may be done by sending bulb data from the telematics unit to the call center for automatic generation and sending of the electronic notification to the customer from the call center. As a part of this process, in some embodiments, the telematics unit 30 can query the driver in the vehicle to determine if the bulb replacement information is desired, so that a customer who does not wish to have this assistance can decline the service. The driver/occupant can be queried by, for example, playing a verbal prompt in the vehicle using audio system 36 or other speaker 37, and then obtaining a spoken reply via microphone 32. In response to an affirmative reply, the telematics unit 30 can then proceed to have the bulb replacement information determined from the identifying information received from BMC 42 and then sent to the customer electronically (e.g., via email, text message, web page, etc.). To obtain the bulb replacement information, telematics unit 30 in some embodiments can perform a lookup of the information using a database of bulb part numbers and/or other ordering information from its memory 54. This lookup can be done using the bulb status information (e.g., the identifying information about which bulb or bulb location failed on the vehicle) that was received from BMC 42. That in-vehicle database can be created as a part of the initial manufacturing of the telematics unit or at a later time, and can be updated as needed or desired. In other embodiments, the bulb replacement information can be determined at the call center, and this can be done by sending bulb data from the telematics unit to the call center. This bulb data can be the same bulb status information, or at least the identifying information about which bulb failed, that was originally received from BMC 42. The bulb data can be sent to the call center using any suitable wireless communication method; for example, as data in an SMS message or via a packet data connection.

Upon receiving the bulb information from the telematics unit, the call center can perform a look up of the bulb replacement information using its database 84, and the looked up information can then be emailed or otherwise provided to the customer to assist them in obtaining the correct replacement part. The replacement part may be the specific bulb itself, or it may be a module or other multi-component part that includes the bulb (e.g., a group of LEDs that come pre-assembled on a common base). In some embodiments, bulb replacement information is sent using the same approach for each customer using the service that receives a bulb outage notification; e.g., by email. In other embodiments, the communication method used for a particular customer can be based upon preference data previously received for the customer, such that one customer might want to be notified via email, whereas another via text message, or another might want to obtain notifications via personal web page that is provided by the call center and accessible to the customer via a unique URL or login. This allows a customer to provide the vehicle or call center with a preferred subscriber specified communication method that is to be used for any electronic communication in general, or at least for the bulb outage notifications in particular. This preference data can be saved in database 84, telematics memory 54, or elsewhere.

### Method

FIG. 3 depicts a method of detecting and responding to a bulb outage that can use the hardware and overall communication system shown in FIGS. 1 and 2. The method 100 begins at step 110 with monitoring of various bulbs on the vehicle; either interior bulbs, exterior bulbs, or both. This involves monitoring for an abnormal condition at one of the bulb locations that is indicative of a bulb outage. In the communication system 10 described above, this monitoring can be done using BMC 42 or other suitable circuitry. Upon determining that an abnormal condition (i.e., a bulb outage) has occurred (step 120), the process then moves to step 130 where information indicative of the bulb outage is provided to the telematics unit 30. As discussed above, this can be done by providing bulb status information that is indicative of the bulb outage and the particular bulb or bulb location so that a parts lookup can be done to obtain the bulb replacement information. The bulb status information might in some embodiments only be produced when a bulb that has failed and might only identify the bulb or bulb location and nothing else, in which case the mere receipt of the bulb status information indicates that the bulb has failed. In other embodiments, bulb status information may be provided for all bulbs on the vehicle, or all of a group of bulbs (e.g., only bulbs used in the exterior lamps), and indicate their operational status (good or failed). Thus, the bulb status information may specifically provide the telematics unit with a failure notification for a bulb, or may instead provide bulb information from which the telematics unit itself can analyze to determine that there has been an outage.

Identifying the bulb from the bulb status information can be carried out in various ways depending upon the implementation. In some embodiments, the bulb status information received over the communications bus by the telematics unit will include a unique identifier of the bulb; in other implementations it may include an identification of the vehicle location or module having the failed bulb and, from this, the telematics unit or call center can determine which bulb has failed. Other ways of determining which bulb has failed with become apparent to those skilled in the art.

As noted above, telematics unit 30 can receive this bulb status information over the vehicle bus 44; in other embodiments, it can be sent and received by the telematics unit via any other suitable wired or wireless communication method. In response to receiving this bulb status information, telematics unit 30 then provides a bulb outage notification to a desired recipient associated with the vehicle (e.g., the driver, owner, telematics service subscriber or other designated recipient). This is indicated at step 140 in FIG. 3. This notification can be, or can include, a prompt querying the recipient as to whether they want the bulb replacement information. For example, where the notification is provided verbally within the vehicle, the telematics unit could play an audio message (e.g., a prerecorded or speech synthesized message) over the audio system 36; e.g., “Your left rear brake light has failed. Do you wish to have replacement part information emailed to you?” Or, such a notification and prompt could be supplied via text message or other means. When presented in the vehicle, the bulb outage notification can be presented immediately if, for example, the vehicle is on indicating a driver is present, or can be presented subsequently, such as by setting a trigger in response to receiving the bulb status information, and then presenting the prompt following a subsequent occurrence of the trigger. For example, an ignition on trigger could be set in the telematics unit 30 such that, the next time it detects the ignition being switched on, it thereafter presents the notification in the vehicle. Other triggers can be used, such as triggering to play the prompt when the driver initiates or finishes a voice session using the automated speech recognition features of telematics unit 30.

At step 150, a reply to the bulb outage notification is received from the recipient; for example, verbally as a spoken input received via the microphone 32. If it is determined from the replay that the bulb replacement information is desired, then a parts lookup is carried out at step 160 using bulb information that indicates which bulb failed. In some embodiments, this step 160 is done at the vehicle, in which case the bulb status information can be used to lookup a parts number or other bulb replacement information from a database stored at the vehicle, such as in telematics memory 54. In other embodiments, this is done by first sending bulb information (e.g., bulb data obtained from the bulb status information) from the vehicle to the call center in response to the recipient's reply at step 150, and then performing the lookup at the call center. The database lookup of bulb replacement information can, in some embodiments, involve using the bulb status information to determine a part number or other designation that can be used for ordering the bulb from a dealership, independent parts supplier, or other source. In other embodiments, the bulb status information (e.g., originally supplied by BMC 42) may include the part number, in which case a part number lookup is not needed and so the bulb replacement information might instead comprise additional information, such as a more specific identification of the failed bulb location on the vehicle, or provide steps or a URL link to steps that describe how to carry out the replacement of the bulb once customer has the replacement bulb in hand. Once the bulb replacement information is obtained, it is then sent to the recipient at step 170 via email or any other suitable communication method including via text message or as a server response to a web page request sent by the recipient using their computer 18. The method 100 then ends.

Some of the basic steps of this method 100 involve (a) receiving bulb status information at a telematics unit installed onboard a vehicle; (b) obtaining bulb replacement information using the bulb data; and (c) providing the bulb replacement information to a recipient associated with the vehicle, wherein these steps are carried out automatically using at least one processing device. The recipient can be, for example, the vehicle owner or a dealership or other parts supplier for the vehicle, in which case the parts supplier can use the bulb replacement information to order the replacement bulb so that it is ready for pickup by the customer. The parts supplier can then contact the customer to inform him or her that the bulb is ready to be picked up or mailed or shipped to the customer if desired. It is not necessary in all embodiments that an initial bulb outage notification and/or query be provided to the customer prior to supplying the bulb replacement information. Rather, the bulb outage notification can be provided as a single notification that includes the bulb replacement information obtained from a lookup either at the vehicle or at the call center or other remote facility. In other embodiments (such as in method 100), a first bulb outage notification can be sent that includes a query prompting the subscriber to respond as to whether or not the subscriber would like to have the bulb replacement information provided. If so, the bulb replacement information can be obtained via a part lookup using the bulb status information and that replacement information can be sent to the subscriber via a second bulb outage notification. The steps (a)-(c) identified above can, in some embodiments, be done mostly or entirely from the vehicle using the telematics unit 30, such that at least steps (a) and (b) are carried out using processor 52. In other embodiments, step (a) is carried out automatically using the telematics unit and its processor while step (b) is carried out automatically at the call center, such as where the telematics unit sends the bulb data to the call center which then obtains the bulb replacement information by using the bulb data to carry out a parts lookup at the remote facility.

As noted above, the steps described above that are carried out by telematics unit 30 can be implemented by suitable programming of processor 52, and the computer readable program to do this can be stored in telematics memory 54. The particular programming needed and choice of programming language used for a particular application will be apparent to those skilled in the art. Also, the telematics unit and back office hardware and programming used for automatically generating and sending the electronic notifications discussed above are known to those skilled in the art; for example, see US. Patent Application Publication No. 2007/0173992 entitled Vehicle Email Notification System and Method, the complete contents of which are hereby incorporated by reference. This electronic notification can either be a dedicated message to report the bulb outage, or can be included as a part of providing other vehicle information to the subscriber. In this latter case, for example, the bulb outage information can be included in a monthly or other diagnostic report emailed to the user, as shown in FIG. 3 of the above-identified US. Patent Application Publication No. 2007/0173992.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, although the illustrated embodiments described above utilize a call center in at least some implementations to receive bulb data from the vehicle and send notifications to the customer, it will be appreciated that the call center is but one of a number of different types of remote facilities that can be used to carry out these functions. Other remote facilities can be used in addition to or in lieu of the call center. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of detecting and responding to a bulb outage on a vehicle, comprising the steps of:
(a) receiving bulb status information at a telematics unit installed onboard a vehicle, the bulb status information indicating the failure of a bulb on the vehicle and providing bulb data for identifying the bulb;
(b) obtaining bulb replacement information using the bulb data; and
(c) providing the bulb replacement information to a recipient associated with the vehicle;
wherein steps (a)-(c) are carried out automatically using at least one processing device.

2. The method of claim 1, further comprising, prior to step (b), the steps of playing a verbal prompt in the vehicle in response to receiving the bulb status information and obtaining a reply to the verbal prompt from an occupant of the vehicle, and wherein steps (b) and (c) are carried out in response to the occupant's reply.

3. The method of claim 1, wherein step (a) further comprises receiving the bulb status information via a communication bus on the vehicle by monitoring the communication bus for messages sent from a vehicle system module that reports bulb outages over the communication bus.

4. The method of claim 1, wherein step (b) further comprises sending the bulb data to a remote facility and obtaining the bulb replacement information by using the bulb data to carry out a parts lookup at the remote facility; and wherein step (c) further comprises electronically transmitting the bulb replacement information to the recipient, whereby step (a) is carried out automatically at the vehicle and step (b) is carried out automatically at the remote facility.

5. The method of claim 1, wherein step (c) further comprises determining a subscriber specified communication method using stored subscriber preference data and sending the bulb replacement information to the subscriber using the specified communication method.

6. The method of claim 1, wherein step (c) further comprises sending the bulb replacement information to a parts supplier.

7. A telematics unit for detecting and responding to a bulb outage on a vehicle, comprising:
a processor;
computer readable memory accessible by the processor; and
wireless communication circuitry connected to the processor;
wherein the processor receives messages from other vehicle system modules and communicates with a remote facility via the communication circuitry using a wireless communication system; and
wherein the processor operates under control of programming stored in the memory to carry out the steps of:
receiving, from one of the vehicle system modules, bulb status information that is indicative of the failure of a bulb on the vehicle;
presenting a prompt in the vehicle via a vehicle user interface in response to receiving the bulb status information;
receiving a reply to the prompt from an occupant of the vehicle; and
sending bulb information to the remote facility via the communication circuitry in response to the occupant's reply.

8. A telematics unit as defined in claim 7, wherein the processor operates under control of the programming to present the prompt as an audio message via one or more speakers in the vehicle; and to receive the reply from a spoken input received from the occupant.

9. A telematics unit as defined in claim 7, wherein the processor operates under control of the programming to receive the bulb status information via a communication bus on the vehicle by monitoring the communication bus for messages sent from one of the vehicle system modules that reports bulb outages over the communication bus.

10. A telematics unit as defined in claim 7, wherein the processor operates under control of the programming to set a trigger in response to receiving the bulb status information and to present the prompt following a subsequent occurrence of the trigger.

11. A telematics unit as defined in claim 7, wherein the processor operates under control of the programming to send the bulb information via an SMS or packet data transmission via the communication circuitry.

12. A method of detecting and responding to a bulb outage on a vehicle, comprising the steps of:
(a) monitoring bulb operation at a plurality of exterior lamp locations on a vehicle;
(b) determining an abnormal condition at one of the exterior lamp locations indicative of a bulb outage;
(c) providing information indicative of the bulb outage to a telematics unit on the vehicle;
(d) sending a bulb outage notification to a recipient associated with the vehicle in response to the information received by the telematics unit, the bulb outage notification prompting the recipient to specify whether bulb replacement information is desired;
(e) receiving a reply to the bulb outage notification from the recipient;
(f) sending bulb information from the telematics unit to a remote facility in response to the recipient's reply;
(g) performing a database lookup at the central facility using the bulb information and obtaining the bulb replacement information via the database lookup; and
(h) sending the bulb replacement information electronically to the recipient.

13. The method of claim 12, wherein step (c) further comprises providing the telematics unit with bulb status information indicative of the bulb outage and with bulb data for identifying the bulb, and wherein in step (f) the bulb information includes at least some of the bulb data.

14. The method of claim 12, wherein step (c) further comprises sending the bulb status information over a communication bus in the vehicle and receiving the bulb status information at the telematics unit connected to the communication bus.

15. The method of claim 12, wherein step (g) further comprises obtaining a part number by performing a parts lookup using the bulb information.

16. The method of claim 12, wherein step (h) further comprises including the bulb replacement information in a vehicle diagnostic email that is sent to the recipient and that contains other vehicle diagnostic information.
